(19) United States
(12) Patent Application Publication
(10) Pub. No.: US 2013/0293042 A1
(43) Pub. Date: Nov. 7, 2013

(54) AIR-COOLED ELECTRICAL MACHINE

(71) Applicants: Lubomir A. Ribarov, West Hartford, CT (US); Jacek F. Gieras, Glastonbury, CT (US)

(72) Inventors: Lubomir A. Ribarov, West Hartford, CT (US); Jacek F. Gieras, Glastonbury, CT (US)

(21) Appl. No.: 13/465,082

(22) Filed: May 7, 2012

(51) Int. Cl. H02K 9/02

(52) U.S. Cl. 310/59

(57) ABSTRACT

An electrical machine, especially permanent magnet machine, is comprised of a stator and a rotor rotatable relative to the stator. The rotor and stator are separated from each other by an air gap. A boundary layer control maintains a desired boundary layer thickness in the air gap. The boundary layer control maintains optimal cooling, which minimizes the electrical machine's overall dimensions while maximizing its power density.

### BACKGROUND OF THE INVENTION

This disclosure relates to an air-cooled electrical machine, especially a permanent magnet machine that utilizes boundary layer control to improve cooling and increase power density.

Advanced power applications, like for example, miniature turbine generators, dental hand-pieces, precision tools, ultra high speed motors, etc., require high speed electrical machines with rotors that must be capable of operating at very high speeds, i.e. speeds in excess of 250,000 rpm, while also maintaining structural integrity. Concerns with this type of application include the extreme centrifugal forces, which cause large mechanical stresses in the rotors, as well as potentially insufficient cooling for both the rotor and stator.

A typical permanent magnet rotor uses a metal/composite laminated retaining sleeve which allows the high-speed rotor to be positioned at a very small distance, i.e. a small air gap, from an inner wall of the associated stator. It is desirable that this air gap be minimal to avoid eddy current losses in the conductive sleeve; however, from a thermodynamic perspective it is desirable that this air gap be larger to provide a better heat transfer coefficient between the rotor and stator. Thus, historically these two concepts have been at odds.

### SUMMARY OF THE INVENTION

In one exemplary embodiment, an electrical machine comprises a stator and a rotor rotatable relative to the stator about an axis. The rotor and stator are separated by an air gap. A boundary layer control maintains a desired boundary layer thickness in the air gap.

In a further embodiment of the above, the boundary layer control comprises a suction feature.

In a further embodiment of any of the above, the suction feature comprises a plurality of suction holes formed within an inner surface of the stator.

In a further embodiment of any of the above, the stator comprises a cylinder having an outer surface spaced radially outwardly from the inner surface, and the plurality of suction holes extend through a thickness of the stator from the inner surface to the outer surface.

In a further embodiment of any of the above, the plurality of suction holes are spaced circumferentially about the inner surface of the stator.

In a further embodiment of any of the above, the plurality of suction holes are spaced axially apart from each other along a length of the stator extending along the axis.

In a further embodiment of any of the above, the plurality of suction holes are spaced circumferentially about the inner surface of the stator, and wherein the plurality of suction holes are spaced axially apart from each other along a length of the stator extending along the axis.

In a further embodiment of any of the above, the air gap has a radial thickness that is greater than zero and less than 1.50 mm (0.06 inches).

These and other features of this application will be best understood from the following specification and drawings, the following of which is a brief description.

### BRIEF DESCRIPTION OF THE DRAWINGS

FIG. 1 schematically illustrates an electrical machine with boundary layer control.

FIG. 2A is a cross-sectional side view of a boundary layer thickness in an electrical machine without boundary layer control.

FIG. 2B is a cross-sectional side view of a boundary layer thickness in an electrical machine with boundary layer control.

FIG. 3 is a schematic illustration of one example application for the electrical machine of FIG. 2B.

### DETAILED DESCRIPTION

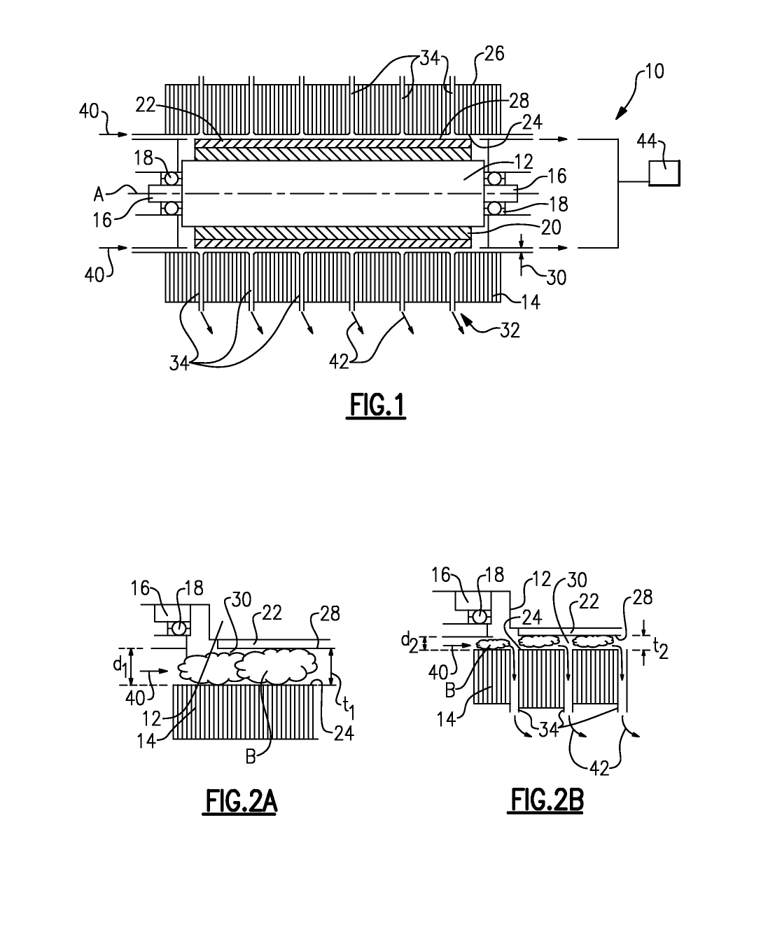

FIG. 1 schematically illustrates an electrical machine 10, such as a permanent magnet machine for example, that includes a rotor 12 and a stator 14. Rotor shaft ends 16 are supported by bearings 18 such that the rotor 12 rotates about an axis A relative to the stator 14. One or more magnets 20 and a retaining sleeve 22 are mounted for rotation with the rotor 12. How the permanent magnet machine 10 operates to generate driving power is known and will not be discussed in detail.

In one example, the stator 14 comprises a cylindrical body having an inner peripheral surface 24 and an outer peripheral surface 26 spaced radially outwardly of the inner peripheral surface. An outer surface 28 of the sleeve 22 is radially spaced from the inner peripheral surface 24 of the stator 14 by an air gap 30.

A boundary layer control 32 is used to maintain a desired boundary layer thickness in the air gap 30. Boundary layer generally refers to a layer of reduced velocity in fluids, such as air for example, that is immediately adjacent to a surface of a solid past which the fluid is flowing. In one example, the boundary layer control 32 comprises a suction feature. In one example, the suction feature comprises a plurality of holes 34 that are formed in the stator 14. The holes 34 extend through a thickness of the stator 14 from the inner peripheral surface 24 to the outer peripheral surface 26. The holes 34 are circumferentially spaced about the inner peripheral surface 24 and extend along a length of the stator 14.

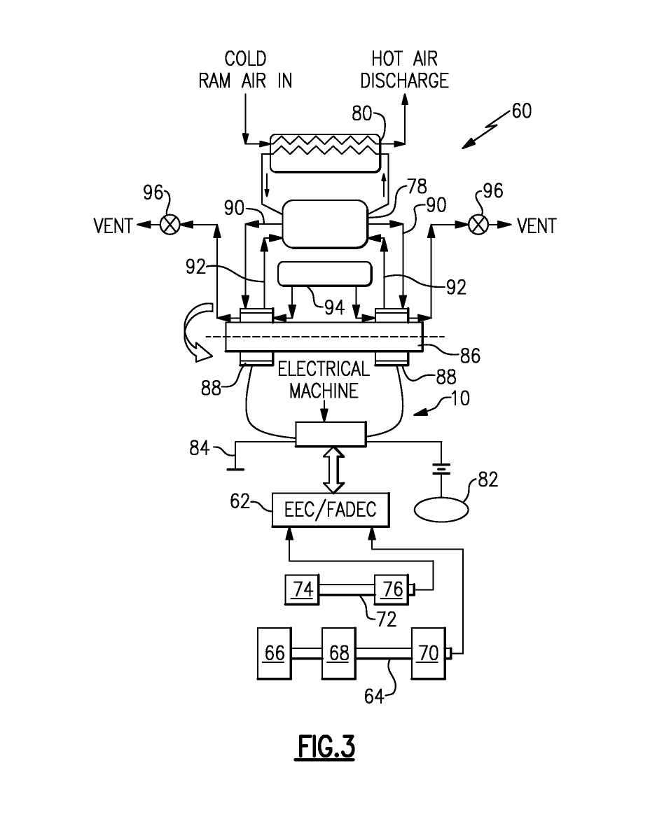

FIG. 2A shows an example that does not utilize boundary layer control. The rotor 12 and stator 14 are separated by a first gap t₁ Specifically between the outer surface 28 of the sleeve 22, and the peripheral surface 24 of the stator 14, respectively. The boundary layer B is defined by a corresponding thickness d₁ that sufficiently fills the gap, t₁, such that d₁=t₁. FIG. 2B shows an example that uses boundary layer control via suction. In this example, the boundary layer, B, is defined by a thickness d₂ that is significantly less than d₁. This, in turn, allows the air gap, t₂, between the stator 14 and rotor 12 to be significantly reduced to a gap thickness t₂ which is significantly less than t₁.

The subject electrical machine is capable of operating at very high speeds, i.e. in excess of 250,000 rpm, and at very high temperatures, i.e. in excess of 290 degrees Celsius (554 degrees Fahrenheit). Using boundary layer control vastly improves cooling and allows the air gap to be minimized to increase power density.

In one example, the working gas is air or nitrogen (N₂); however, other gases could also be used. High pressure gas is pumped into the stator 14 in a direction along the axis A (as indicated by arrows 40) of the rotor 12 and is then discharged through a check valve 44 to the ambient as shown in FIG. 1. The inlet gas pressure is higher than the outlet gas pressure and the resulting pressure differential provides the coolant flow to the stator 14. The holes 34 provide for suction through which exits the stator 14 is indicated by arrows 42.

The type of fluid flow's regime is identified by a Reynolds number. The Reynolds number, Re, is a dimensionless number, ρV1/μ, where V is the fluid velocity, ρ is the density, μ is the viscosity, and 1 is a characteristic dimension of the system. The value of Re indicates the regime of the fluid flow. When a certain Re is exceeded, instable flow can be generated. For example, a configuration such as shown in FIG. 1, i.e. the viscous flow between two concentric cylinders, of which the inner cylinder is in motion and the outer cylinder is at rest (i.e., Couette flow), demonstrates an example of a typical unstable flow stratification caused by centrifugal forces. When such flow instabilities occur (due to reaching a certain critical Re), certain toroidal flow vortices, known as Taylor vortices, can appear whose axes are located along the circumference of the inner cylinder and which rotate in alternately opposite directions. Instability in the flow is not desirable as it adversely affects the operating efficiency of the machine.

The condition for the onset of instability is given by the Taylor number, Ta, which is:

Ta=(Uᵢ/d)/ν*(d/Rᵢ)>41.3

Where: d=the radial width of the gap; Rᵢ is the inner radius of the inner cylinder, i.e. the rotor; Uᵢ is the peripheral velocity of the inner cylinder; and ν is the kinematic viscosity (ν=μ/ρ, which is the ratio of the viscosity μ to the density ρ). There are three defined Taylor number, Ta, ranges of flow between cylinders:

Ta<41.3 (laminar Couette flow)

41.3<Ta<400 (laminar flow with Taylor vortices)

Ta>400 (turbulent flow)

For high speed applications, such as those contemplated here, it is expected that the predominant flow will include high levels of turbulence, i.e. Ta>400. Under such extreme conditions, the velocity gradient in the narrow air gap is very high resulting in a wide variety of shear stresses. However, it is desirable to minimize the boundary layer thickness in the annulus (i.e., the “air gap” 30) between the rotor and the stator, thus suppressing the formation of the undesirable Taylor vortices. As shown, the condition for the onset of this instability is given by keeping Ta<41.3 (i.e. laminar Couette flow regime). This type of flow minimizes the torque coefficient between the two cylinders resulting in lower “pumping” losses.

Suction is used in order to achieve this boundary layer control. The effect of suction is the removal of the slowest (decelerated) fluid particles from the boundary layer before they can cause a separation leading to turbulence and inefficient heat transfer. By applying suction (see FIG. 2B) at discrete locations along the inner peripheral surface 24 of the stator 14, a new, i.e. thinner boundary layer is formed within the air gap 30, which is capable of overcoming the adverse pressure gradient that forms behind the suction openings. This leads to a decrease in the pressure drag, which is reduced due to the absence of flow separation.

Controlling the boundary layer thickness in this manner provides a sufficient amount of cooling between the rotor and stator. Further, the thinner boundary layer minimizes the parasitic loss of “windage effects,” while also allowing for a smaller air gap thickness, which is critical in increasing the power density of the machine 10. In one example, the subject boundary layer control allows the gap 30 to be reduced within a range that is greater than 0 and less than 1.50 mm (0.06 inches).

It should be understood that using suction to control boundary layer thickness is just one method of control and that other methods and apparatus can be used to control the boundary layer thickness. For example, injecting different types of gases into the air gap or generating acceleration through the air gap can also be used to control boundary layer thickness as needed.

Using boundary layer control within the permanent magnet machine or any other cylindrical-rotor electric machine results in a more compact machine size, a high mechanical reliability, an effective heat transfer, and intensive cooling capability. The configuration uses very few moving parts and is durable in adverse ambient conditions. Further, the electrical machine is capable of operating at high speeds and there are no thermal limitations due to active fuel and/or air cooling (see FIG. 3).

FIG. 3 is a schematic illustration of one example application for the electrical machine 10. Active monitoring and control are needed to avoid excessively high air pressures to minimize pneumatic instabilities. Such a control can be utilized for an aircraft environmental control system 60. The system 60 includes an electronic engine control (EEC) 62, which is part of the on-board Full Authority Digital Engine Control (FADEC) system that monitors engine pressure ratio and shaft (spool) speeds. Aircraft gas turbine engines can include two or more shafts (spools), which connect fan, compressor, and turbine components as known.

In one example of a twin-spool gas turbine engine, a low speed shaft 64 interconnects a fan 66, a low pressure compressor 68, and a low pressure turbine 70, while a high speed shaft 72 interconnects a high pressure compressor 74 and a high pressure turbine 76. As known, airflow is compressed by the low pressure compressor 68 then the high pressure compressor 74, mixed and burned with fuel in a combustor, then expanded over the high pressure turbine 76 and low pressure turbine 70. The turbines 70, 76 rotationally drive the respective low speed shaft 64 and high speed shaft 72 in response to the expansion of the hot products of the combustion process.

Since the electronic engine control 62 normally monitors the speeds of the shafts 64, 72, it is an ideal application for an active control implementation for the engine based controls. High pressure air can be supplied as a byproduct gas from an on-board air separation module that supplies a nitrogen enriched air stream to an on-board nitrogen generating system (NGS). The air separation module (ASM) is part of an aircraft fuel inerting system where the nitrogen enriched air steam is an airflow product that results after nitrogen has been separated from the ambient air and pumped into an aircraft fuel tank 78. This provides a safe inerting environment with displaced volatile fuel vapors.

In order to prevent compressed air from reaching elevated working temperatures, a fuel-cooling loop is used to circulate outside of the rotor. Cold fuel from the tank 78 provides an effective heat sink medium for dissipating compressed air heat through convective/conductive heat transfer. Heated fuel can then be utilized for burning directly in the combustor to provide better fuel atomization, mixing, and burning as the fuel is pre-heated. Alternatively, if not needed, the pre-heated fuel can be returned to the tank 78 and mixed with the resident colder fuel. If this increases fuel temperature above a desired level (typically limited by the coking-resistance properties of the fuel), an efficient air-to-fuel heat exchanger 80 can be used to cool down the fuel using inlet ambient cold ram air as the heat sink. Shown in FIG. 3 is a counter-flow heat exchanger (80), but any other highly-efficient, compact, and light-weight heat exchanger can be used. The resulting heated air can be discharged overboard as shown in FIG. 3.

As shown in FIG. 3, the electrical machine 10 is controlled by the electronic engine control 62 and is coupled to a power source 82 and is grounded at 84. The machine 10 drives shaft 86, which is supported by a pair of bearings 88. Cooling flow is circulated to the bearings 88 from the tank 78 along path 90 and is returned to the tank 78 along path 92. Compressed nitrogen 94 (either pumped directly from the ASM and/or from an on-board N₂ storage tank) is also circulated through the bearings 88 for cooling purposes and is vented via check valves 96.

Although an embodiment of this invention has been disclosed, a worker of ordinary skill in this art would recognize that certain modifications would come within the scope of this invention. For that reason, the following claims should be studied to determine the true scope and content of this invention.

1. An electrical machine comprising:
a stator;
a rotor rotatable relative to the stator about an axis, the rotor and stator being separated by an air gap; and
a boundary layer control to maintain a desired boundary layer thickness in the air gap.

2. The electrical machine according to claim 1, wherein the boundary layer control comprises a suction feature.

3. The electrical machine according to claim 2, wherein the suction feature comprises a plurality of suction holes formed within an inner surface of the stator.

4. The electrical machine according to claim 3, wherein the stator comprises a cylinder having an outer surface spaced radially outwardly from the inner surface, and wherein the plurality of suction holes extend through a thickness of the stator from the inner surface to the outer surface.

5. The electrical machine according to claim 4, wherein the plurality of suction holes are spaced circumferentially about the inner surface of the stator.

6. The electrical machine according to claim 4, wherein the plurality of suction holes are spaced axially apart from each other along a length of the stator extending along the axis.

7. The electrical machine according to claim 4, wherein the plurality of suction holes are spaced circumferentially about the inner surface of the stator, and wherein the plurality of suction holes are spaced axially apart from each other along a length of the stator extending along the axis.

8. The electrical machine according to claim 1, wherein the air gap has a radial thickness that is greater than zero and less than 1.50 mm (0.06 inches).

9. The electrical machine according 1, wherein a cooling fluid is pumped through the air gap.

10. The electrical machine according 9, wherein the cooling fluid is one of air or nitrogen.

11. An electrical machine comprising:
a rotor rotatable about an axis;
a stator defining an inner peripheral surface and an outer peripheral surface spaced radially outwardly of the inner peripheral surface, and wherein an outer surface of the rotor and the inner peripheral surface of the stator are separated by an air gap; and
a boundary layer control to maintain a desired boundary layer thickness in the air gap.

12. The electrical machine according to claim 11, wherein the boundary layer control comprises a suction feature.

13. The electrical machine according to claim 12, wherein the suction feature comprises a plurality of suction holes formed within the inner peripheral surface of the stator.

14. The electrical machine according to claim 13, wherein the plurality of suction holes extend through a thickness of the stator from the inner peripheral surface to the outer peripheral surface.

15. The electrical machine according to claim 14, wherein the plurality of suction holes are spaced circumferentially about the inner peripheral surface of the stator.

16. The electrical machine according to claim 14, wherein the plurality of suction holes are spaced axially apart from each other along a length of the stator extending along the axis.

17. The electrical machine according to claim 14, wherein the plurality of suction holes are spaced circumferentially about the inner peripheral surface of the stator, and wherein the plurality of suction holes are spaced axially apart from each other along a length of the stator extending along the axis.

18. The electrical machine according to claim 11, wherein the air gap has a radial thickness that is greater than zero and less than 1.50 mm (0.06 inches).

19. The electrical machine according 11, wherein the rotor is configured to rotate at speeds of at least 250,000 rpm.

20. The electrical machine according 19, wherein a cooling fluid is pumped through the air gap.
